(19) United States
(12) Patent Application Publication
(10) Pub. No.: US 2007/0146985 A1
(43) Pub. Date: Jun. 28, 2007

(54) Systems for integrating peripheral devices with hand-held computing devices

(75) Inventors: Roger Wayne Mick, Chalfort, PA (US); Vincent A. Turco JR., Bensalem, PA (US); Michael Francis Walsh, Horsham, PA (US); Daniel J. Dolan, Perkasie, PA (US); Eric Eckstein, Merion Station, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Two Technologies, Inc, Horsham, PA (US)

(21) Appl. No.: 11/515,434

(22) Filed: Aug. 31, 2006

Related U.S. Application Data
(60) Provisional application No. 60/713,444, filed on Aug. 31, 2005.

(51) Int. Cl. G06F 1/16

(52) U.S. Cl. 361/683

(57) ABSTRACT

Embodiments of systems include a capsule that houses one or more peripheral devices, such as radios, capable of being used with hand-held computing devices such as RFID tag readers. A receptacle can be mounted on the hand-held computing device. The receptacle receives the capsule. Electrical connectors on the capsule and the receptacle mate when the receptacle is received by the receptacle, to electrically connect the peripheral device and the hand-held computing device. A seal is provided to prevent infiltration of water, dust, and other contaminates into the electrical connectors. A portion of the capsule is exposed when the capsule is located in the receptacle, to accommodate external antennas, connectors, optical ports, etc. that may be required by the peripheral device.

This application claims priority under 35 U.S.C. § 119(e) to U.S. provisional application no. 60/713,444, filed Aug. 31, 2006, the contents of which is incorporated by reference herein in its entirety.

### TECHNICAL FIELD

The present application relates to hand-held computing devices such as radio frequency identification (RFID) tag readers. The application also relates to peripheral devices, such as radios, used with hand-held computing devices.

### BACKGROUND

Peripheral devices, such as radios, are commonly used with hand-held computing devices such as RFID tag readers. It may be desirable in some applications to mount the peripheral device on the exterior of the hand-held computing device, so that the peripheral device can be installed and removed without disassembling the hand-held computing device.

A peripheral device usually requires some type of electrical interface. Mounting the peripheral device on the exterior of the hand-held computing device may expose the electrical interface to the ambient environment, making the interface susceptible to infiltration by water, dust, and other contaminates.

The peripheral device needs to be securely held on the hand-held computing device, and protected from impacts caused by dropping or other misuse. Many peripheral devices, however, include external features such as antennas, connectors, optical ports, etc. that preclude covering the entire peripheral device with protective structure.

An ongoing need therefore exists for a system for integrating a peripheral device with a hand-held computing device, where the system securely receives the peripheral device, permits the peripheral device to be installed and removed with minimal effort on the part of the user, protects the peripheral device from impact loads, and protects the electrical interface associated with peripheral device from contaminates.

### SUMMARY

Embodiments of systems include a capsule that houses one or more peripheral devices, such as radios, capable of being used with hand-held computing devices such as RFID tag readers. A receptacle can be mounted on the hand-held computing device. The receptacle receives the capsule. Electrical connectors on the capsule and the receptacle mate when the receptacle is received by the receptacle, to electrically connect the peripheral device and the hand-held computing device. A seal is provided to prevent infiltration of water, dust, and other contaminates into the electrical connectors. A portion of the capsule is exposed when the capsule is located in the receptacle, to accommodate external antennas, connectors, optical ports, etc. that may be required by the peripheral device.

Embodiments of systems comprise a peripheral device for use with a hand-held computing device, and a capsule housing the peripheral device. The capsule comprises a first electrical connector electrically connected to the peripheral device.

The system also comprises a receptacle capable of being mounted on the hand-held computing device. The receptacle receives the capsule. The receptacle comprises a second electrical connector electrically connected to the hand-held computing device. The second electrical connector mates with the first electrical connector when the receptacle receives the capsule. At least one of the receptacle and the capsule comprises a seal that seals an interface between the first and second electrical connectors.

Other embodiments of systems comprise a peripheral device capable of use with a hand-held computing device, and an enclosure housing the peripheral device. The enclosure comprises a first electrical connector electrically connected to the peripheral device. The systems also comprise a receptacle capable of being mounted on the exterior of the hand-held computing device. The receptacle defines a cavity that receives the enclosure. The receptacle covers only a portion of the enclosure when the enclosure is received by the cavity. The receptacle comprises a second electrical connector that mates with the first electrical connector.

Embodiments of kits for electrically and mechanically coupling a peripheral device to a hand-held computing device comprises a capsule capable of enclosing the peripheral device and comprising a first electrical connector, and a receptacle capable of being mounted on an exterior surface of the hand-held computing device and receiving the capsule.

The receptacle comprises a second electrical connector that mates with the first electrical connector when the receptacle receives the capsule. At least one of the capsule and the receptacle comprises a seal that seals an interface between the first and second electrical connectors when the first and second electrical connectors are mated.

Embodiments of kits for mounting a peripheral device on a hand-held computing device comprise a capsule defining an internal volume that receives the peripheral device. The capsule comprises a first electrical connector.

The kits also comprise a receptacle for mounting on an exterior of the hand-held computing device. The receptacle defines a pocket for the peripheral device. The receptacle covers only a portion of the capsule when the capsule is positioned within the pocket. The receptacle comprises a second electrical connector that mates with the first electrical connector when the capsule is positioned within the pocket.

Methods comprise mounting a peripheral device within an enclosure, and mounting a receptacle for the enclosure on an exterior surface of a hand held computing device. The methods also comprise inserting the enclosure into a cavity defined by the receptacle so that an electrical connector of the enclosure mates with an electrical connector of the hand-held computing device and an interface between the electrical connectors is sealed.

### BRIEF DESCRIPTION OF THE DRAWINGS

The foregoing summary, as well as the following detailed description of embodiments, are better understood when read in conjunction with the appended diagrammatic drawings. For the purpose of illustrating the embodiments, the drawings diagrammatically depict specific embodiments. The appended claims are not limited, however, to the specific embodiments disclosed in the drawings. In the drawings:

FIG. 1 is a perspective view of an embodiment of a system for electrically and mechanically coupling a peripheral device to a hand-held computing device, installed on a hand-held computing device;

FIG. 2 is a perspective view of the system and the hand-held computing device shown in FIG. 1, with a capsule of the system removed from a receptacle of the system;

FIG. 3 is a perspective view of the system and the hand-held computing device shown in FIGS. 1 and 2, showing the system without the receptacle;

FIG. 4 is a cross-sectional view of the system and the hand-held computing device shown in FIGS. 1-3, taken through the line “A-A” of FIG. 1, showing the system with the capsule removed from the receptacle;

FIG. 5 is a cross-sectional view of the system and the hand-held computing device shown in FIGS. 1-4, taken through the line “C-C” of FIG. 1, showing the capsule without a radio therein;

FIG. 6 is a cross-sectional view of the system and the hand-held computing device shown in FIGS. 1-5, taken through the line “A-A” of FIG. 1, showing the system with the capsule removed from the receptacle;

FIGS. 7 and 8 are cross-sectional views of the system and the hand-held computing device shown in FIGS. 1-6, taken through the line “A-A” of FIG. 1;

FIG. 9 is a cross-sectional view of the system and the hand-held computing device shown in FIGS. 1-8, taken through the line “B-B” of FIG. 1; and

FIG. 10 is a side view of connectors of the receptacle and the system shown in FIGS. 1-9, in a mated condition.

### DETAILED DESCRIPTION OF ILLUSTRATIVE EMBODIMENTS

The figures depict an embodiment of a system 10 for electrically and mechanically connecting a peripheral device, such as a radio 12, to a hand-held computing device 14. The system 10 comprises pack connect, or receptacle 20, and a pack, or capsule 22. The capsule 22 encapsulates the radio 12. The receptacle 20 can be attached to the hand-held computing device 14, and securely receives the capsule 22. The receptacle 20 includes connecting features that mate with complementary connecting features on the capsule 22 to electrically connect the radio 12 and the hand-held computing device 14.

The system 10 is described in connection with a radio such as the radio 12 for exemplary purposes only. The system 10 can be used to electrically and mechanically connect virtually any type of custom-designed or “off-the-shelf” peripheral device to the hand-held computing device 14 including, but not limited to PCMCIA Type III cards; medium-range radio links; global positioning systems (GPS); GSM/GPRS radio; bar-code scanners; radio-frequency identification (RFID) interrogators; cameras; label printers; card swipe readers; etc.

The system 10 can be used to simultaneously couple more than one peripheral device to the hand-held computing device 14. For example, the system 10 can be used to couple both a GPS and a GSM/GPRS to the hand-held computing device 14 on a simultaneous basis. Also, the system 10 can be used in conjunction with hand-held computing devices other than the hand-held computing device 14.

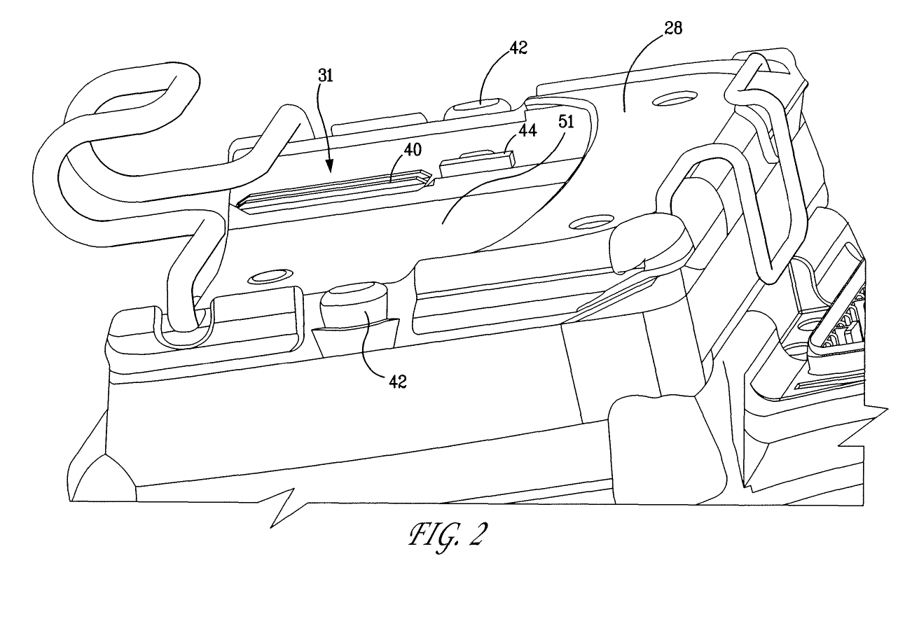

The receptacle 20 includes a first portion 26 and a second portion 28. The first portion 26 can be secured to an external surface 30 of the hand-held computing device 14 by a suitable means such as four screws (more or less than four screws can be used in the alternative). The second portion 28 can be secured to the first portion 26 by a suitable means such as adhesive. The first portion 26 and the second portion 28 define a cavity 31 for receiving a portion of the capsule 22, as shown in FIGS. 2, 4, and 6.

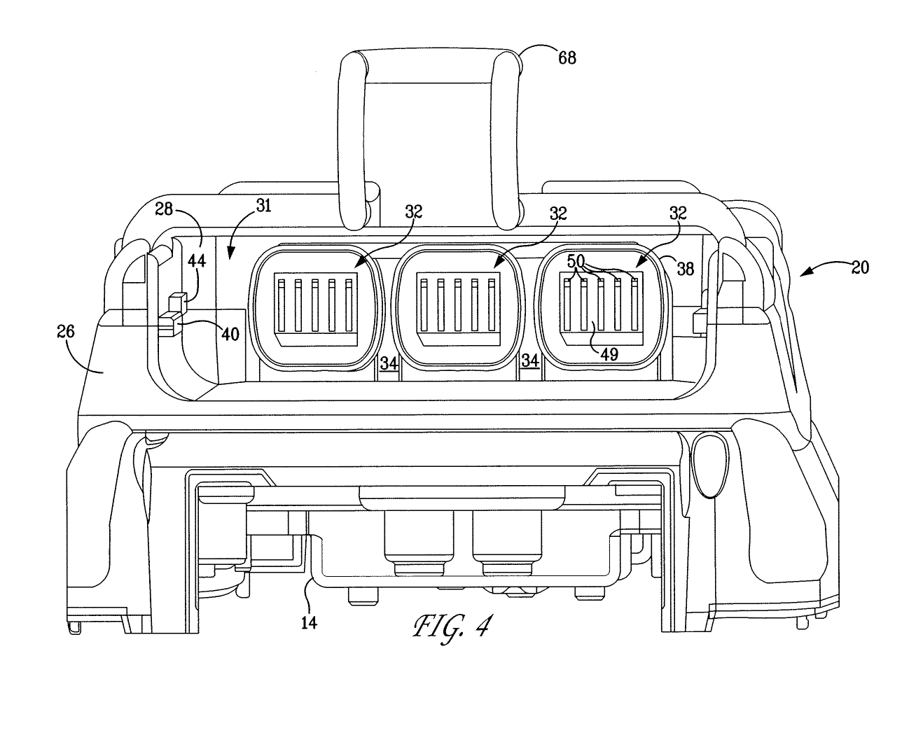

The receptacle 20 can include three electrical connectors 32, and a connector housing 34, as shown in FIG. 4. The use of three connectors 32 is specified for exemplary purposes only. Alternative embodiments can include more, or less than three connectors 32. Moreover, alternative embodiments of the receptacle 20 can be equipped with other types of connectors in lieu of the connectors 32.

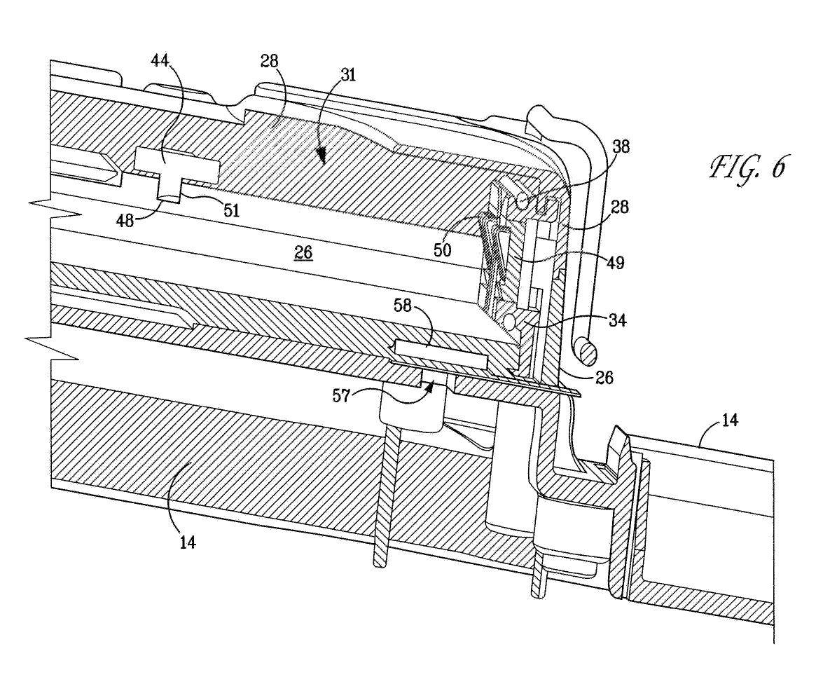

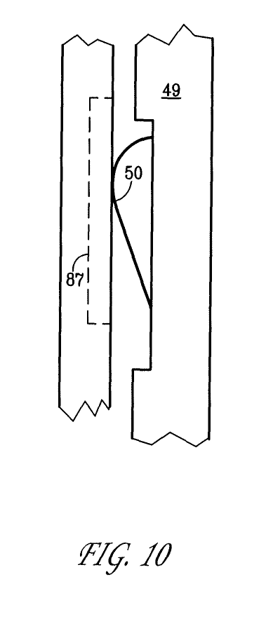

The connectors 32 each comprise a body 49, and a plurality of contacts 50 mounted on the body 49. The contacts 50 can be gold plated. Each contact 50 can be looped, as depicted in FIGS. 6 and 10, so that the contact 50 develops a spring force when the capsule 22 is mated with the receptacle 20.

The connector housing 34 has penetrations formed therein for receiving the connector 32. The body 49 of each connector 32 is can be secured to the housing 34 by adhesive. The adhesive also seals the interface between the connector 32 and the housing 34, and thereby inhibits moisture, dust, and other contaminates from reaching the contacts 50 when the capsule 22 and the receptacle 20 are mated.

The contacts 50 of each connector 32 are electrically connected to the hand-held computing device 14 by a flex circuit (not shown), or other suitable means. The flex circuit extends from the connectors 32, and between the first portion 26 of the receptacle 20 and the surface 30 of the hand-held computing device 14. Access to the interior of the hand-held computing device 14 is provided by an opening 57 formed in the surface 30, as shown in FIG. 6.

A gasket 58 is positioned on the surface 30, around the periphery of the opening 57. The flex circuit 52 can extend through the gasket 58, or between the gasket 58 and the surface 30. The gasket 58 discourages moisture, dust, and other contaminates from entering the interior of the hand-held computing device by way of the opening in the surface 30.

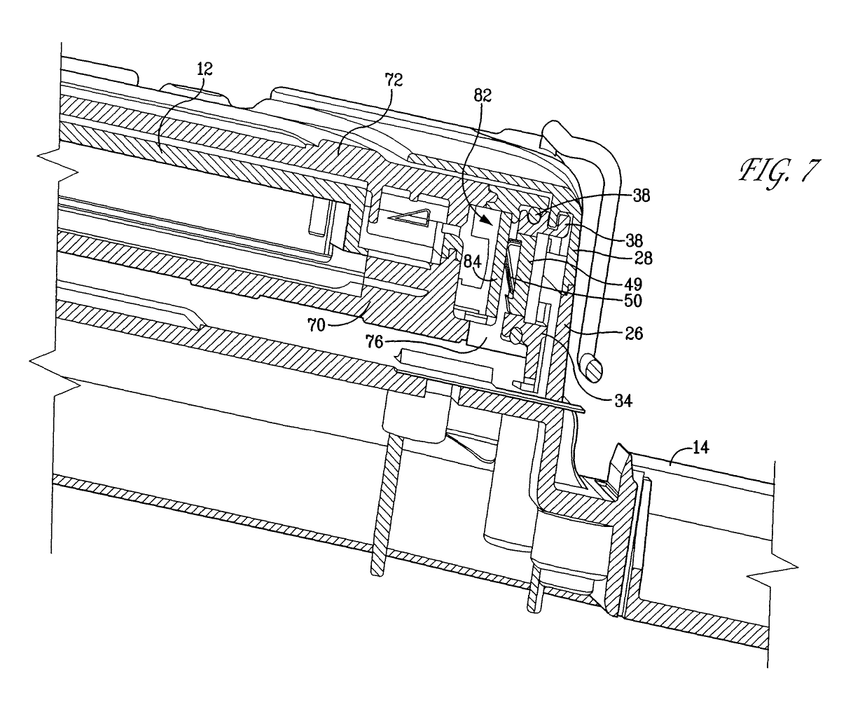

The connector housing 34 is trapped between the first and second portions 26, 28 of the receptacle 20, as depicted in FIGS. 6 and 7. In particular, the first portion 26 has slots formed therein for receiving lower portions the connector housing 34 (from the perspective of FIGS. 6 and 7). The second portion 28 has a lip 36 formed therein. The lip 36 is received by a groove formed in the connector housing 34. Interference between the lip 36 and the connector housing 34, and between the lower portions of the connector housing 34 and the first portion 26 secures the connector housing 34 in position in relation to the first and second portions 20, 22.

Resilient seals 38 are disposed grooves formed in the connector housing 34, proximate each connector 32. The purpose of the seals 38 is discussed below.

The first and second portions 26, 28 and the connector housing 34 can be formed from a rugged, non-metallic, electrically-insulative material such as high-impact plastic. Other types of materials can be used in the alternative. The high-impact plastic of one or both of the first and second portions 26, 28 can be co-molded with a rubberized material so that the rubberized material forms a portion of the outer surface of the first or second portion 26, 28. The rubberized material can improve the ruggedness of the system 10 by enhancing the ability of the system 10 to withstand impacts caused by dropping, bumping, etc.

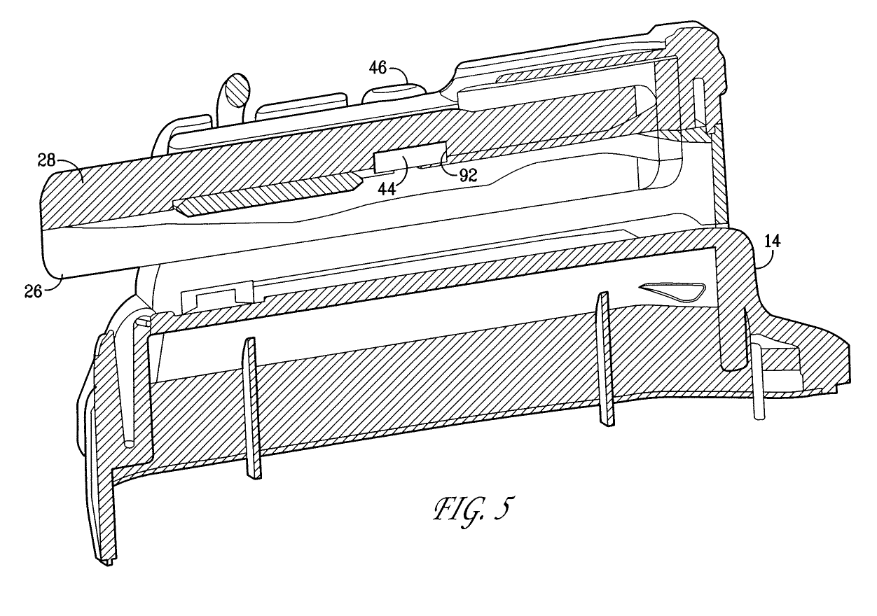

One or both of the first and second portions 26, 28 of the receptacle 20 can have rails 40 formed thereon, as shown in FIGS. 4 and 5. The rails 40 are positioned at opposite sides of the cavity 31, and help to guide the capsule 22 into the cavity 31.

The receptacle 20 can include two locking features 42 depicted in FIGS. 2-5. The locking features 42 are located on opposite sides of the receptacle 20. Each locking feature 42 includes a latch 44, a button 46 secured to the latch 44 by a screw or other suitable means, and a spring 48. Each spring 48 is positioned below its corresponding latch 44, and biases the latch 44 and the button 46 upward, from the perspective of FIGS. 2-5.

Each latch 44, button 46, and spring 48 is accommodated by a cavity 51 defined by the first and second portions 26, 28. A portion of each latch 44 projects into the cavity 31, and is positioned proximate an associated one of the rails 40. Each button 46 projects outward from its associated cavity, so that the button 46 can be accessed by the user.

The receptacle 20 is depicted with a clip 68 that allows the system 10 and the hand-held computing device 14 to be suspended, for example, from a belt, pocket, etc. of the user. Alternative embodiments of the receptacle 20 can be configured without this feature.

The capsule 22 can comprise a first portion 70, a second portion 72, and an end piece 76, as shown in FIGS. 7-9. The first and second portions 70, 72 and the end piece 76 can be formed from a rugged, non-metallic, electrically-insulative material such as high-impact plastic. Other types of materials can be used in the alternative. The high-impact plastic of one or both of the first and second portions 70, 72 can be co-molded with a rubberized material so that the rubberized material forms a portion of the outer surface of the first or second portion 70, 72, to improve the ruggedness of the system 10.

The first portion 70 can be secured to the second portion 72 by, for example, six screws (more or less than six screws and be used in the alternative). The end piece 76 can be secured to the first and second portions 70, 72 by, for example, a total of four screws (more or less than six screws and be used in the alternative). A liquid adhesive or other suitable sealing means, e.g., gaskets, can be applied to the interfaces between the first and second portions 70, 72 and the end piece 76.

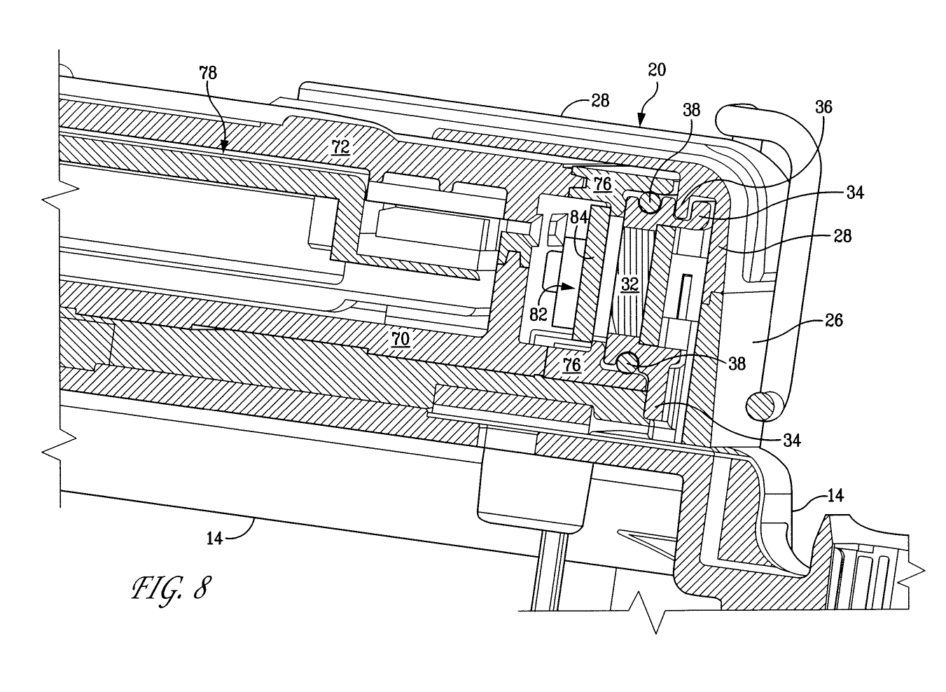

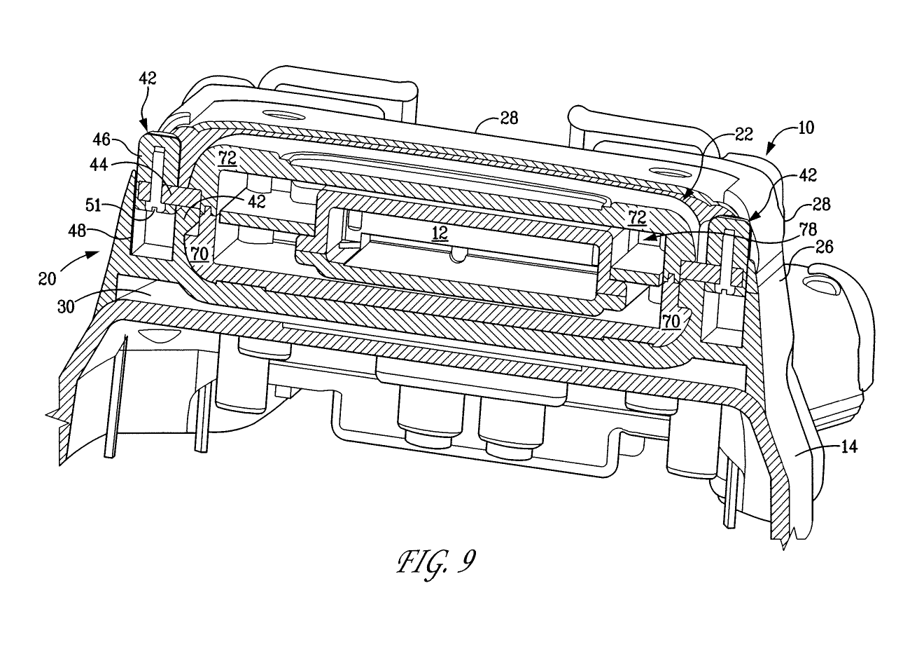

The first portion 70, second portion 72, and end piece 76 define a cavity 78 within the capsule 22, depicted in FIGS. 8 and 9. The cavity 22 receives the radio 12. The radio 12 can be restrained within the cavity 78 by a suitable means. For example, the radio 12 can be sized to fit within the cavity 78 so that minimal clearance exists between the outer perimeter of the radio 12 and the inner periphery of the cavity 78. Clamps, brackets, fasteners, tape, etc. can also be used to restrain the radio 12 in relation to the capsule 22.

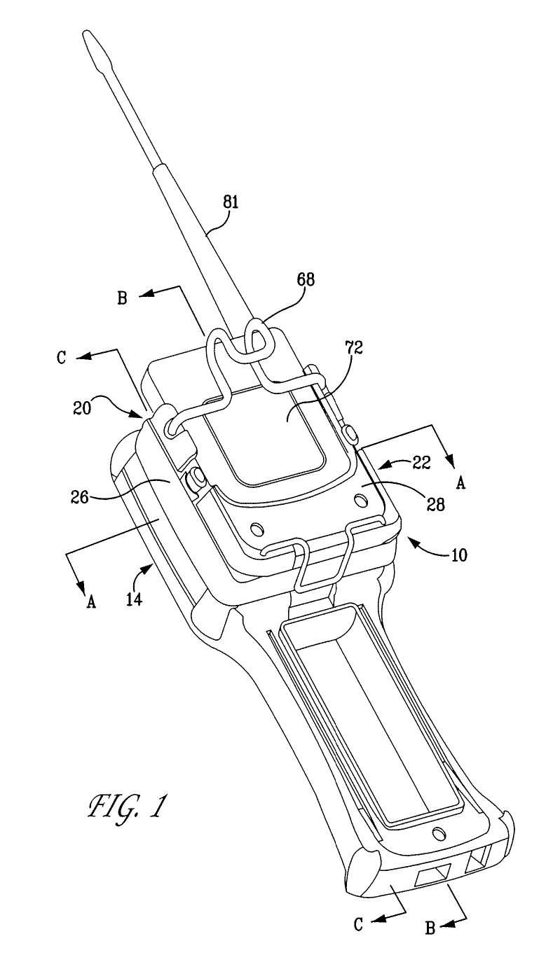

The capsule 22 includes an antenna 81, depicted in FIG. 1. The use of the antenna 81 is disclosed for exemplary purposes only. The need for an antenna or other external device or connection on the capsule 22 is dependent on the type of peripheral device with which the system is used.

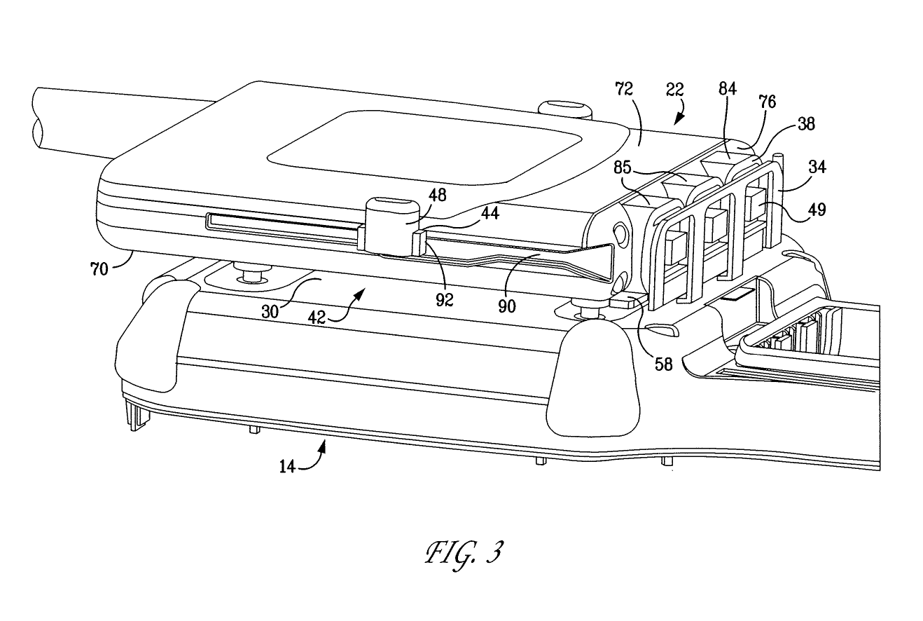

The capsule 22 includes three connectors 82 each comprising a body 84, and a plurality of contacts 87 mounted on the body, as shown in FIGS. 7-10. The end piece 76 has penetrations formed therein for receiving the connectors 82. Sleeves 85 are formed on the end piece 76, and extend around the periphery of each penetration, as shown in FIG. 3. The body 84 of each connector 82 can be secured to the end piece 76 by a suitable means such as adhesive.

The contacts 87 are positioned so that each contact contacts a corresponding contact 50 of the receptacle 20 when the capsule 22 is mated with the receptacle 20, as shown in FIG. 10. The contacts 87 are can be gold plated. Each contact 87 can be disposed on the corresponding body 84 in a substantially flat orientation. In other words, the contacts 87 are not looped, in contradistinction to the contacts 50 of the receptacle 20. The contacts of the connectors 82 can be looped, and the contacts 50 can be substantially flat in alternative embodiments. Moreover, the contacts 87 and the contacts 50 can all be looped, or can all be flat, in other alternative embodiments.

The use of three connectors 82 on the capsule 22 is specified for exemplary purposes only. The optimal number of connectors 82 can vary with the specific requirements of the peripheral device installed in the capsule 22. In particular, the connector configuration for a particular application can be tailored to the power connection, ground connection, and signal transmission requirements for the peripheral device used in that application. Moreover, the alternative embodiments of the capsule 22 can be equipped with other types of connectors.

The first and second portions 70, 72 and the end piece 76 of the capsule 22 define two slots 90 that extend along opposing sides of the capsule 22, as depicted in FIGS. 3, 5, and 9. An end of each slot 90 is open, as shown in FIG. 3. The portion of each slot 90 proximate the open end can be tapered, so that the slot 90 is relatively wide at the open end.

Each slot 90 receives an associated one of the rails 40 of the receptacle 20 as the capsule 22 is mated with the receptacle 20. Each latch 44 also becomes disposed within a corresponding slot 90 as the capsule 22 and the receptacle 20 are mated. The contact between the latch 44 and the upper periphery of the corresponding slot 90 initially forces the latch 44 downward, from the perspective of FIG. 5.

Each slot 90 includes a recessed portion 92, as depicted in FIG. 5. The recessed portion 92 receives a corresponding latch 46 when the capsule 22 is fully inserted into the cavity 31. In particular, each recessed portion 92 aligns with a corresponding latch 46 when the capsule 22 has been fully mated with the receptacle 20. The bias of the springs 48 urges the latches 44 upward, into the recessed portions 92, as depicted in FIG. 5. Each recessed portion 92 is sized to trap the associated latch 46 therein, so that interference between the latch 46 and the periphery of the recessed portion 92 inhibits the capsule 22 from moving in a direction opposite the mating direction. In other words, the latches 44 prevent the capsule 22 from backing out of the cavity 31.

Each contact 87 of the capsule 22 mates with a corresponding contact 50 of the receptacle 20 as the capsule 22 reaches the end of its travel in the mating direction. The sleeves 85 formed on the end piece 76 of the capsule 22 each become disposed around an associated portion of the connector housing 34 of the receptacle 20 as the contacts 87, 50 mate, as shown in FIG. 3. The seals 38 positioned on the connector housing 34 proximate each connector 32 compress as the sleeves 85 mate with the connector housing 34, as depicted in FIGS. 7 and 8. The seal 38 thus forms a gas-tight seal that inhibits moisture, dust, and other contaminates from reaching the contacts 87, 50 once the capsule 22 and the receptacle 20 are mated. Moreover, the establishment of the sealed interface between the connectors 32, 82 requires no effort on the part of the user other than inserting the capsule 22 into the cavity 31.

The configuration of the contacts 50, 86 makes the contact forces between the connectors 32, 82 primarily dependent upon the relative positions of the capsule 22 and the receptacle 20 in the mating direction. The relative positions of the capsule 22 and the receptacle 20, when mated, are determined by the latches 44 and the recessed portions 90. Hence, the contact forces between the connectors 32, 82 are repeatable and predictable.

Moreover, the contacts 50, 86 do not carry any substantial shear forces caused by the restraining effect of the pack connect 22 on the pack 20. In other words, the capsule 22 is restrained by the receptacle 20, and not the connectors 32, 82, which can enhance the ruggedness and reliability of the system 10. The capsule 22 can thus migrate or otherwise move in relation to the receptacle 20 without inducing substantial shear stresses in the contacts 50, 86.

The capsule 22 can thus be mated mechanically and electrically with the receptacle 20, and the critical interfaces between the capsule 22 and the receptacle 20 can be sealed with minimal effort on the part of the user, and without use of additional parts doors, hinges, clutch mechanisms, etc. Moreover, the movement of the buttons 46 as the latches 44 snap into position in the recessed portions 90 can provide the user with a positive visual and audible indication that the capsule 22 has been securely mated with the pack connect.

Removing the capsule 22 from the receptacle 20 requires pushing both buttons 46 on a simultaneous basis to move the latches 44 out of their associated recessed portion 92, while pulling the capsule 22 in a direction opposite the mating direction. This feature can help minimize the potential for accidental or otherwise unintentional separation of the capsule 22 from the receptacle 20.

The receptacle 20 is configured to “capture” five sides of the capsule 22, while leaving a portion of the capsule 22 exposed. The receptacle 20 can thus provide a substantial degree of protection for the capsule 22 when the capsule 22 is dropped, bumped, etc., while allowing the capsule 22 to accommodate external antennas, connectors, optical ports, etc. that may be required by a particular peripheral device. Moreover, the configuration of the receptacle 20 permits the capsule 22 to expand within the receptacle 20 due to factors such as thermal expansion.

Nearly all of the components of the system 10 are non-metallic and non-conductive, thereby minimizing the potential for the system 10 to interfere with the operation of the radio 12 or other peripheral device mounted in the capsule 22. Moreover, positioning the radio 12 or other peripheral device outside of the hand-held computing device 14 can help minimize the potential for interference between the radio 12 or other peripheral device and the electronics within the hand-held computing device 14. In other words, the radio 12 or other peripheral device is in an RF neutral, or “radio-friendly” environment when mounted on the hand-held computing device 14 using the system 10.

The system 10 can be provided to the user as a kit that permits the user to integrate a particular peripheral device with the hand-held computing device 14. In other system 10 can be provided without a peripheral device and with the capsule 22 in an unassembled state. The user can install a peripheral device of the user's choice in the capsule 22. Hence, the kit can provide the user with the option to integrate custom electronics, as well as “off-the-shelf” commercial electronics into the hand-held computing device 14.

The foregoing description is provided for the purpose of explanation and is not to be construed as limiting. While the embodiments have been described with reference to specific embodiments or methods, it is understood that the words which have been used herein are words of description and illustration, rather than words of limitation. Furthermore, although particular embodiments and methods have been described herein, the appended claims are not intended to be limited to the particulars disclosed herein. Those skilled in the relevant art, having the benefit of the teachings of this specification, may effect numerous modifications to the embodiments and methods as described herein, and changes may be made without departing from the scope of the appended claims.

What is claimed:

1. A system, comprising:
a peripheral device for use with a hand-held computing device;
a capsule housing the peripheral device, the capsule comprising a first electrical connector electrically connected to the peripheral device; and
a receptacle capable of being mounted on the hand-held computing device, wherein the receptacle receives the capsule, the receptacle comprises a second electrical connector electrically connected to the hand-held computing device, the second electrical connector mates with the first electrical connector when the receptacle receives the capsule, and at least one of the receptacle and the capsule comprises a seal that seals an interface between the first and second electrical connectors.

2. The system of claim 1, wherein the first electrical connector comprises a first contact, the second electrical connector comprises a second contact, and at least one of the first and second contacts develops a spring force when mated with the other of the first and second contacts.

3. The system of claim 2, wherein at least one of the first and second contacts is looped.

4. The system of claim 3, wherein at least one of the first and second contacts is substantially flat.

5. The system of claim 1, wherein the receptacle further comprises a first portion and a second portion attached to the first portion, the first and second portions defining a first cavity that receives the capsule.

6. The system of claim 5, wherein:
the second electrical connector comprises a body and a contact mounted on the body;
the receptacle further comprises a connector housing having a penetration formed therein for receiving the body; and
an interface between the connector housing and the body is sealed by an adhesive.

7. The system of claim 6, wherein the connector housing is trapped between the first and second portions.

8. The system of claim 7, wherein one of the first portion and the connector housing comprises a lip, and the lip is received by a groove formed in the other of the first portion and the connector housing.

9. The system of claim 5, wherein at least one of the first and second portions is formed from high-impact plastic co-molded with a rubberized material so that the rubberized material forms a portion of a outer surface of the at least one of the first and second portions.

10. The system of claim 1, further comprising a flex circuit electrically connected to the second electrical connector for electrically connecting the second electrical connector to the hand-held computing device.

11. The system of claim 10, wherein the flex circuit can be routed between the receptacle and a housing of the peripheral device.

12. The system of claim 11, wherein the system further comprises a gasket capable of being positioned between the receptacle and the hand-held computing device, and around a hole formed in the housing for providing the flex circuit with access to an interior of the housing.

13. The system of claim 5, wherein the capsule comprises a first portion and a second portion attached to the first portion of the capsule, the first and second portions of the capsule defining a second cavity that receives the peripheral device.

14. The system of claim 13, wherein the at least one of the first and second portions of the receptacle comprises a rail positioned on a side of the first cavity, and at least one of the first and second portions of the capsule comprises a slot that receives the rail when the receptacle receives the capsule.

15. The system of claim 14, wherein the receptacle further comprises a latch that becomes disposed in a recessed portion of the slot when the capsule is fully inserted into the first cavity, and interference between the latch and a periphery of the slot retains the capsule in the first cavity.

16. The system of claim 15, wherein:
the receptacle further comprises a button secured to the latch, and a spring that biases the latch toward a first position;
the latch is disposed in the recessed portion of the slot when the latch is in the first position and the capsule is fully inserted into the first cavity;
the latch moves to a second position in response to pressure exerted on the button; and
the periphery of the slot does not interfere with the latch when the latch is in the second position whereby the capsule can be removed from the first cavity when the button is pressed.

17. The system of claim 13, wherein the capsule further comprises an end piece attached to the first and second portions of the capsule, the end piece having a penetration formed therein for receiving the first electrical connector.

18. The system of claim 13, wherein at least one of the first and second portions of the capsule is formed from high-impact plastic co-molded with a rubberized material so that the rubberized material forms a portion of a outer surface of the at least one of the first and second portions.

19. The system of claim 17, wherein the first electrical connector comprises a body secured to the end piece, and a contact mounted on the body; and the end piece comprises a sleeve that becomes disposed around and compresses the seal as the capsule is received by the receptacle.

20. The system of claim 1, wherein the peripheral device is a radio.

21. The system of clam 13, wherein the receptacle covers only a portion of the first and second portions of the capsule when the receptacle receives the capsule.

22. The system of claim 21, wherein interference between not more than five sides of the capsule and a periphery of the first cavity restrains the capsule when the capsule is received by the receptacle.

23. The system of claim 6, wherein the seal is mounted on the connector housing and compresses in response to contact with the capsule as the receptacle receives the capsule.

24. The system of claim 1, wherein the receptacle comprises a clip for suspending the receptacle.

25. A system, comprising:
a peripheral device capable of use with a hand-held computing device;
an enclosure housing the peripheral device and comprising a first electrical connector electrically connected to the peripheral device; and
a receptacle capable of being mounted on the exterior of the hand-held computing device and defining a cavity that receives the enclosure, wherein the receptacle covers only a portion of the enclosure when the enclosure is received by the cavity, and the receptacle comprises a second electrical connector that mates with the first electrical connector.

26. The system of claim 25, wherein interference between not more than five sides of the enclosure and a periphery of the cavity restrains the enclosure when the enclosure is positioned within the cavity.

27. The system of claim 25, wherein the receptacle covers not more than five side of the enclosure when the enclosure is positioned within the cavity whereby a portion of the enclosure is exposed when the enclosure is positioned within the cavity.

28. The system of claim 25, wherein the first electrical connector comprises a first contact, the second electrical connector comprises a second contact, and at least one of the first and second contacts develops a spring force when mated with the other of the first and second contacts.

29. The system of claim 28, wherein at least one of the first and second contacts is looped.

30. The system of claim 25, wherein the enclosure comprises a first portion and a second portion attached to the first portion, the first and second portions define a volume that receives the peripheral device, and at least one of the first and second portions is formed from high-impact plastic co-molded with a rubberized material so that the rubberized material forms a portion of a outer surface of the at least one of the first and second portions.

31. The system of claim 25, wherein the receptacle comprises a first portion and a second portion attached to the first portion, the first and second portions define the cavity, and at least one of the first and second portions is formed from high-impact plastic co-molded with a rubberized material so that the rubberized material forms a portion of a outer surface of the at least one of the first and second portions.

32. The system of claim 25, wherein the peripheral device is a radio.

33. The system of claim 25, wherein:
the receptacle comprises a rail positioned on a side of the cavity;
the enclosure defines a slot that receives the rail when the receptacle receives the enclosure;
the receptacle comprises a latch that becomes disposed in a recessed portion of the slot when the enclosure is fully inserted into the cavity; and
interference between the latch and a periphery of the slot retains the enclosure in the cavity.

34. The system of claim 33, wherein:
the receptacle further comprises a button secured to the latch, and a spring that biases the latch toward a first position;
the latch is disposed in the recessed portion of the slot when the latch is in the first position and the enclosure is fully inserted into the cavity;
the latch moves to a second position in response to pressure exerted on the button; and
the periphery of the slot does not interfere with the latch when the latch is in the second position whereby the enclosure can be removed from the cavity when the button is pressed.

35. The system of claim 25, wherein at least one of the receptacle and the enclosure comprises a seal that is compressed in response to contact with other of the enclosure and the receptacle when the enclosure is positioned in the cavity.

36. The system of claim 35, wherein:
the second electrical connector comprises a body and a contact mounted on the body;
the receptacle further comprises a connector housing having a penetration formed therein for receiving the body;
the seal is mounted on the connector housing; and
the first electrical connector comprises a body, contact mounted on the body, and a sleeve that becomes disposed around and compresses the seal when the enclosure is positioned in the cavity.

37. A kit for electrically and mechanically coupling a peripheral device to a hand-held computing device, comprising:
a capsule capable of enclosing the peripheral device and comprising a first electrical connector; and
a receptacle capable of being mounted on an exterior surface of the hand-held computing device and receiving the capsule, the receptacle comprising a second electrical connector that mates with the first electrical connector when the receptacle receives the capsule, wherein at least one of the capsule and the receptacle comprises a seal that seals an interface between the first and second electrical connectors when the first and second electrical connectors are mated.

38. A kit for mounting a peripheral device on a hand-held computing device, comprising:
a capsule defining an internal volume that receives the peripheral device, the capsule comprising a first electrical connector; and
a receptacle for mounting on an exterior of the hand-held computing device, the receptacle defining a pocket for the peripheral device, wherein the receptacle covers only a portion of the capsule and the receptacle comprises a second electrical connector that mates with the first electrical connector when the capsule is positioned within the pocket.

39. A method, comprising:
mounting a peripheral device within an enclosure;
mounting a receptacle for the enclosure on an exterior surface of a hand held computing device; and
inserting the enclosure into a cavity defined by the receptacle so that an electrical connector of the enclosure mates with an electrical connector of the hand-held computing device and an interface between the electrical connectors is sealed.

40. The method of claim 39, further comprising inserting the enclosure into the cavity so that the receptacle covers only a portion of the enclosure.
